(19) United States
(12) Patent Application Publication
(10) Pub. No.: US 2023/0324193 A1
(43) Pub. Date: Oct. 12, 2023

(54) CONTROL APPARATUS, SYSTEM, AND OPERATING METHOD OF SYSTEM

(71) Applicant: TOYOTA JIDOSHA KABUSHIKI KAISHA, Toyota-shi (JP)

(72) Inventors: Chikage KUBO, Tokyo-to (JP); Kazuya NISHIMURA, Anjo-shi (JP); Wataru MINOURA, Nagoya-shi (JP); Yuki TATSUMOTO, Seto-shi (JP); Soutaro KANEKO, Nagoya-shi (JP)

(21) Appl. No.: 18/187,013

(22) Filed: Mar. 21, 2023

(30) Foreign Application Priority Data
Mar. 22, 2022 (JP) 2022-046039

(51) Int. Cl. G01C 21/34

(52) U.S. Cl. CPC G01C 21/3484; G01C 21/3492

(57) ABSTRACT

A control apparatus includes a memory configured to store a history of travel of a vehicle, a communication interface, and a controller configured to transmit and receive information to and from another apparatus via the communication interface. The controller is configured to output a first history for a first period in response to a predetermined instruction during the first period and to refrain from outputting the first history, even upon receiving the predetermined instruction, during a second period partitioned from the first period based on information transmitted by a terminal apparatus.

### CROSS-REFERENCE TO RELATED APPLICATION

This application claims priority to Japanese Patent Application No. 2022-046039, filed on Mar. 22, 2022, the entire contents of which are incorporated herein by reference.

### TECHNICAL FIELD

The present disclosure relates to a control apparatus, a system, and an operating method of a system.

### BACKGROUND

Various technologies have been proposed to support users in car sharing, during which vehicles are shared by a plurality of users. For example, Patent Literature (PTL) 1 discloses technology for managing the status of the staff of a car sharing provider during a service in which vehicles are delivered by the staff.

### Citation List

### Patent Literature

PTL 1: JP2017-215769 A

### SUMMARY

In car sharing, there is room for improvement in the convenience for vehicle owners or users.

A control apparatus and the like that can improve the convenience for vehicle owners or users are described below.

A control apparatus according to the present disclosure includes:
a memory configured to store a history of travel of a vehicle;
a communication interface; and
a controller configured to transmit and receive information to and from another apparatus via the communication interface, wherein
the controller is configured to output a first history for a first period in response to a predetermined instruction during the first period and to refrain from outputting the first history, even upon receiving the predetermined instruction, during a second period partitioned from the first period based on information transmitted by a terminal apparatus.

A system according to the present disclosure includes a control apparatus and a terminal apparatus configured to communicate information with each other, wherein
the control apparatus is configured to store a history of travel of a vehicle and output a first history for a first period in response to a predetermined instruction during the first period,
the terminal apparatus is configured to transmit information for partitioning a second period from the first period to the control apparatus, and
the control apparatus is configured to refrain from outputting the first history, even upon receiving the predetermined instruction, during the second period.

An operating method of a system according to the present disclosure is an operating method of a system including a control apparatus and a terminal apparatus configured to communicate information with each other, the operating method including:
storing, by the control apparatus, a history of travel of a vehicle and outputting a first history for a first period in response to a predetermined instruction during the first period; and
transmitting, by the terminal apparatus, information for partitioning a second period from the first period to the control apparatus, wherein
the control apparatus refrains from outputting the first history, even upon receiving the predetermined instruction, during the second period.

According to the control apparatus and the like of the present disclosure, the convenience for vehicle owners or users can be improved.

### BRIEF DESCRIPTION OF THE DRAWINGS

In the accompanying drawings:

FIG. 1 is a diagram illustrating an example configuration of an information processing system;

FIG. 2 is a diagram illustrating an example configuration of a server apparatus;

FIG. 3 is a diagram illustrating an example configuration of a terminal apparatus;

FIG. 4 is a diagram illustrating a configuration example of a vehicle;

FIG. 5 is a sequence diagram illustrating an operation example of the information processing system;

FIG. 6 is a sequence diagram illustrating an operation example of the information processing system according to a modification;

FIG. 7 is a flowchart illustrating an example of operations of the control apparatus; and

FIG. 8 is a diagram illustrating the history.

### DETAILED DESCRIPTION

Embodiments are described below.

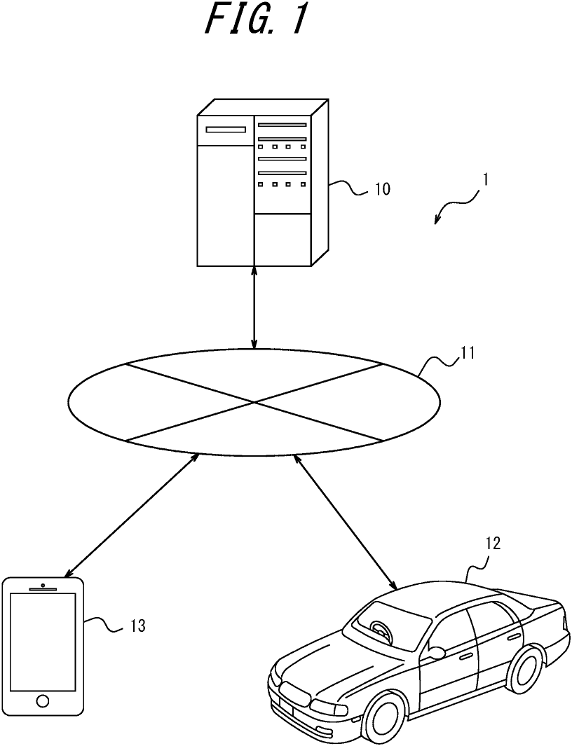

FIG. 1 is a diagram illustrating a configuration example of an information processing system according to an embodiment. An information processing system 1 includes one or more each of a server apparatus 10, a vehicle 12, and a terminal apparatus 13 communicably connected to each other via a network 11. The server apparatus 10 is, for example, a server computer that belongs to a cloud computing system or other computing system and functions as a server that implements various functions. The vehicle 12 is a vehicle used in car sharing and is a passenger car, a commercial vehicle, or the like provided with communication functions and information processing functions. The vehicle 12 is connected to the network 11 via a mobile communication network. The vehicle 12 is driven manually, but a portion of driving may be automated. The vehicle 12 is any type of automobile such as a gasoline vehicle, a Battery Electric Vehicle (BEV), a Hybrid Electric Vehicle (HEV), a Plug-in Hybrid Electric Vehicle (PHEV), or a Fuel Cell Electric Vehicle (FCEV). The terminal apparatus 13 is an information processing apparatus, with a communication function, used by the user of the vehicle 12. The terminal apparatus 13 is, for example, a smartphone, a tablet terminal, or the like. The network 11 is the Internet, for example, but may also be an ad-hoc network, a LAN, a Metropolitan Area Network (MAN), other networks, or a combination of two or more thereof.

In the present embodiment, the information processing system 1 supports the management of the vehicle 12 provided for car sharing. The vehicle 12 is normally used by its owner and is provided for use by a user other than the owner by the user reserving use of the vehicle 12. An in-vehicle apparatus and/or a server apparatus 10 correspond to the “control apparatus” in the present embodiment. The control apparatus includes a memory configured to store a history of travel of the vehicle 12, outputs a history (owner usage history) for a period in which the owner uses the vehicle 12 (owner usage period) in response to a predetermined instruction during the owner usage period, and refrains from outputting the owner usage history, even upon receiving the predetermined instruction, during a period (user usage period) partitioned from the owner usage period based on predetermined information transmitted by the terminal apparatus 13 of the user of the vehicle 12. The history is relevant to the privacy of the owner, for example, who used the vehicle 12, since the history includes information on searched routes, travel routes, and points included in the searched routes or travel routes. According to the control apparatus of the present embodiment, the owner’s privacy is protected, since the owner usage history during the owner usage period is outputted to the owner, but the owner usage history is not outputted to the user during the user usage period. Therefore, at least the convenience for the owner can be improved.

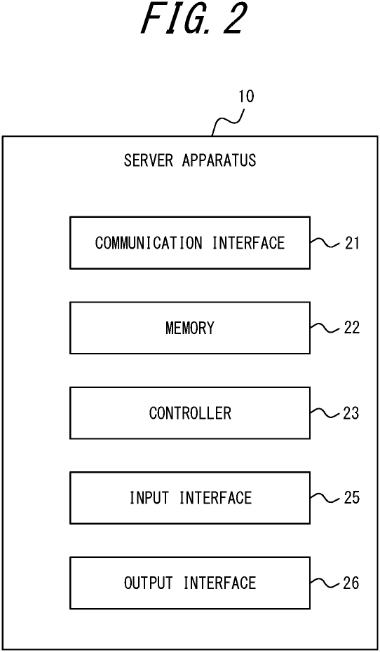

FIG. 2 illustrates an example configuration of the server apparatus 10. The server apparatus 10 includes a communication interface 21, a memory 22, a controller 23, an input interface 25, and an output interface 26. The server apparatus 10 may be a single server computer or may be two or more computers that are communicably connected to each other and operate in cooperation. In this case, the configuration illustrated in FIG. 2 can be arranged among two or more server computers as appropriate.

The communication interface 21 includes one or more interfaces for communication. The interface for communication is, for example, a LAN interface. The communication interface 21 receives information to be used for the operations of the server apparatus 10 and transmits information obtained by the operations of the server apparatus 10. The server apparatus 10 is connected to the network 11 by the communication interface 21 and communicates information with the vehicle 12 or the terminal apparatus 13 via the network 11.

The memory 22 includes, for example, one or more semiconductor memories, one or more magnetic memories, one or more optical memories, or a combination of at least two of these types, to function as main memory, auxiliary memory, or cache memory. The semiconductor memory is, for example, Random Access Memory (RAM) or Read Only Memory (ROM). The RAM is, for example, Static RAM (SRAM) or Dynamic RAM (DRAM). The ROM is, for example, Electrically Erasable Programmable ROM (EEPROM). The memory 22 stores information to be used for the operations of the server apparatus 10 and information obtained by the operations of the server apparatus 10.

The controller 23 includes one or more processors, one or more dedicated circuits, or a combination thereof. The processor is a general purpose processor, such as a central processing unit (CPU), or a dedicated processor, such as a graphics processing unit (GPU), specialized for a particular process. The dedicated circuit is, for example, a field-programmable gate array (FPGA), an application specific integrated circuit (ASIC), or the like. The controller 23 executes information processing related to operations of the server apparatus 10 while controlling components of the server apparatus 10.

The input interface 25 includes one or more interfaces for input. The interface for input is, for example, a physical key, a capacitive key, a pointing device, a touch screen integrally provided with a display, or a microphone that receives audio input. The input interface 25 accepts operations to input information used for operation of the server apparatus 10 and transmits the inputted information to the controller 23.

The output interface 26 includes one or more interfaces for output. The interface for output is, for example, a display or a speaker. The display is, for example, a liquid crystal display (LCD) or an organic electro-luminescent (EL) display. The output interface 26 outputs information obtained by the operations of the server apparatus 10.

The functions of the server apparatus 10 are realized by a processor included in the controller 23 executing a control program. The control program is a program for causing a server computer to execute the processing of steps included in the operations of the server apparatus 10, thereby enabling the server computer to realize the functions corresponding to the processing of the steps. That is, the control program is a program for causing a computer to function as the server apparatus 10. Some or all of the functions of the server apparatus 10 may be realized by a dedicated circuit included in the controller 23. The control program may be stored on a non-transitory recording/storage medium readable by the server apparatus 10 and be read from the medium by the server apparatus 10.

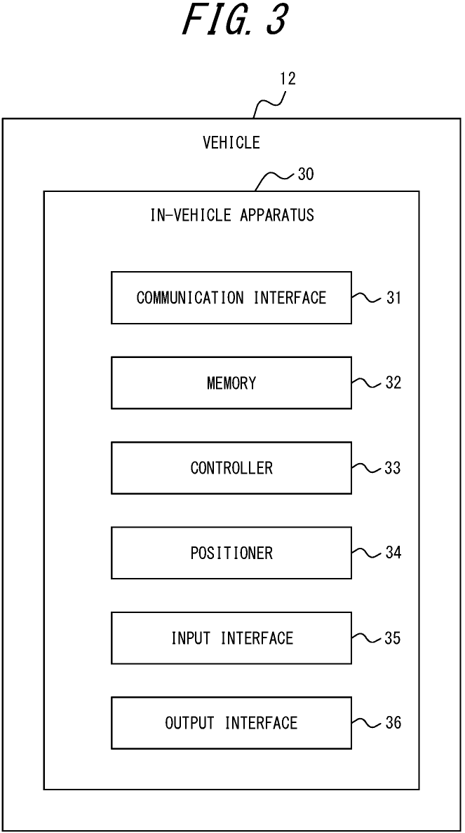

FIG. 3 illustrates a configuration example of the vehicle 12. An in-vehicle apparatus 30 is installed in the vehicle 12. The in-vehicle apparatus 30 includes a communication interface 31, a memory 32, a controller 33, a positioner 34, an input interface 35, and an output interface 36. These components may be configured as a single control apparatus, by two or more control apparatuses, or by other apparatuses, such as a control apparatus and a communication device. The control apparatus includes an electronic control unit (ECU), for example. The communication device includes a data communication module (DCM), for example. The control apparatus may be configured to include a personal computer, a tablet terminal, a smartphone terminal, a navigation apparatus, or the like. The components are communicably connected to each other, or to other devices and apparatuses in the vehicle 12, by an in-vehicle network compliant with standards such as a controller area network (CAN).

The communication interface 31 includes one or more interfaces for communication. Examples of the interface for communication include an interface corresponding to mobile communication standards, such as Long Term Evolution (LTE), 4th Generation (4G), or 5th Generation (5G). The communication interface includes an interface compliant with a short-range wireless communication standard such as Wi-Fi^{®} (Wi-Fi is a registered trademark in Japan, other countries, or both), Bluetooth^{®} (Bluetooth is a registered trademark in Japan, other countries, or both), or infrared communication. The communication interface 31 receives information to be used for the operations of the controller 33 and transmits information obtained by the operations of the controller 33. The controller 33 connects to the network 11 using the communication interface 31 through a mobile communication base station and communicates information with other apparatuses via the network 11.

The memory 32 includes, for example, one or more semiconductor memories, one or more magnetic memories, one or more optical memories, or a combination of at least two of these types. The semiconductor memory is, for example, RAM or ROM. The RAM is, for example, SRAM or DRAM. The ROM is, for example, EEPROM. The memory 32 functions as, for example, a main memory, an auxiliary memory, or a cache memory. The memory 32 stores information to be used for the operations of the controller 33 and information obtained by the operations of the in-vehicle apparatus 30.

The controller 33 includes one or more processors, one or more dedicated circuits, or a combination thereof. Examples of the processor include a general purpose processor such as a CPU and a dedicated processor dedicated to specific processing. The dedicated circuit is, for example, an FPGA or an ASIC. The controller 33 executes information processing related to operations of the vehicle 12 while controlling the components of the controller 33.

The positioner 34 includes one or more Global Navigation Satellite System (GNSS) receivers. The GNSS includes, for example, at least one of Global Positioning System (GPS), Quasi-Zenith Satellite System (QZSS), BeiDou, Global Navigation Satellite System (GLONASS), and Galileo. The positioner 34 acquires the positional information for the vehicle 12 and transmits the positional information to the controller 33.

The input interface 35 includes one or more interfaces for input. The interface for input is, for example, a physical key, a capacitive key, a pointing device, a touch screen integrally provided with a display, or a microphone that receives audio input. The interface for input may further include a camera or IC card reader that captures images or image codes. The input interface 35 accepts user operations to input information used for operation of the controller 33 and transmits the inputted information to the controller 33.

The output interface 36 includes one or more interfaces for output. The interface for output is, for example, a display or a speaker. The display is, for example, an LCD or an organic EL display. The output interface 36 outputs the information obtained by the operation of controller 33, for example, to the user.

The functions of the controller 33 are realized by a processor included in the controller 33 executing a control program. The control program is a program for causing a computer to execute the processing of steps included in operations of the controller 33, thereby enabling the computer to realize the functions corresponding to the processing of the steps. That is, the control program is a program for causing a computer to function as the controller 33. Some or all of the functions of the controller 33 may be realized by a dedicated circuit included in the controller 33.

The controller 33 generates information for control of various mechanisms and apparatuses of the vehicle 12 and transmits the information for control to the control circuits of the various mechanisms and apparatuses to control the mechanisms and apparatuses.

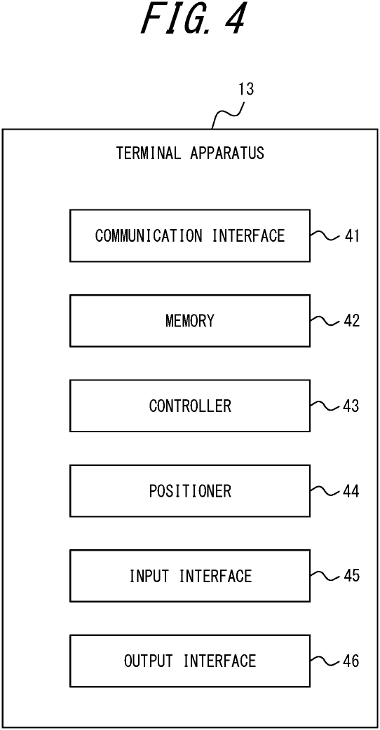

FIG. 4 is a diagram illustrating a configuration of the terminal apparatus 13. The terminal apparatus 13 is, for example, an information terminal apparatus such as a smartphone, a tablet terminal apparatus, or the like. The terminal apparatus 13 includes a communication interface 41, a memory 42, a controller 43, a positioner 44, an input interface 45, and an output interface 46.

The communication interface 41 includes one or more interfaces for communication compatible with wired or wireless LAN standards. Examples of the interface for communication include an interface corresponding to mobile communication standards, such as LTE, 4G, or 5G. The communication interface includes an interface compliant with a short-range wireless communication standard such as Wi-Fi, Bluetooth, or infrared communication. The terminal apparatus 13 connects to the network 11 via a nearby router apparatus or mobile communication base station using the communication interface 41 and communicates information with other apparatuses over the network 11.

The memory 42 includes, for example, one or more semiconductor memories, one or more magnetic memories, one or more optical memories, or a combination of at least two of these types. The semiconductor memory is, for example, RAM or ROM. The RAM is, for example, SRAM or DRAM. The ROM is, for example, EEPROM. The memory 42 functions as, for example, a main memory, an auxiliary memory, or a cache memory. The memory 42 stores information to be used for the operations of the controller 43 and information obtained by the operations of the controller 43.

The controller 43 has one or more general purpose processors such as CPUs or micro processing units (MPUs) or one or more dedicated processors that are dedicated to specific processing. Alternatively, the controller 43 may have one or more dedicated circuits such as FPGAs or ASICs. The controller 43 is configured to perform overall control of the operations of the terminal apparatus 13 by operating according to the control/processing programs or operating according to operation procedures implemented in the form of circuits. The controller 43 then transmits and receives various types of information to and from the server apparatus 10 and the like via the communication interface 41 and executes the operations according to the present embodiment.

The positioner 44 includes one or more GNSS receivers. GNSS includes, for example, GPS, QZSS, BeiDou, GLONASS, and/or Galileo. The positioner 44 acquires the positional information for the terminal apparatus 13 and transmits the positional information to the controller 43.

The input interface 45 includes one or more interfaces for input. The interface for input is, for example, a physical key, a capacitive key, a pointing device, a touch screen integrally provided with a display, or a microphone that receives audio input. The interface for input may further include a camera or IC card reader that captures images or image codes. The input interface 45 accepts operations for inputting information to be used in the operations of the controller 43 and transmits the inputted information to the controller 43.

The output interface 46 includes one or more interfaces for output. The interface for output is, for example, a display or a speaker. The display is, for example, an LCD or an organic EL display. The output interface 46 outputs information obtained by the operations of the controller 43.

The functions of the controller 43 are realized by a processor included in the controller 43 executing a control program. The control program is a program for causing the processor to function as the controller 43. Some or all of the functions of the controller 43 may be realized by a dedicated circuit included in the controller 43.

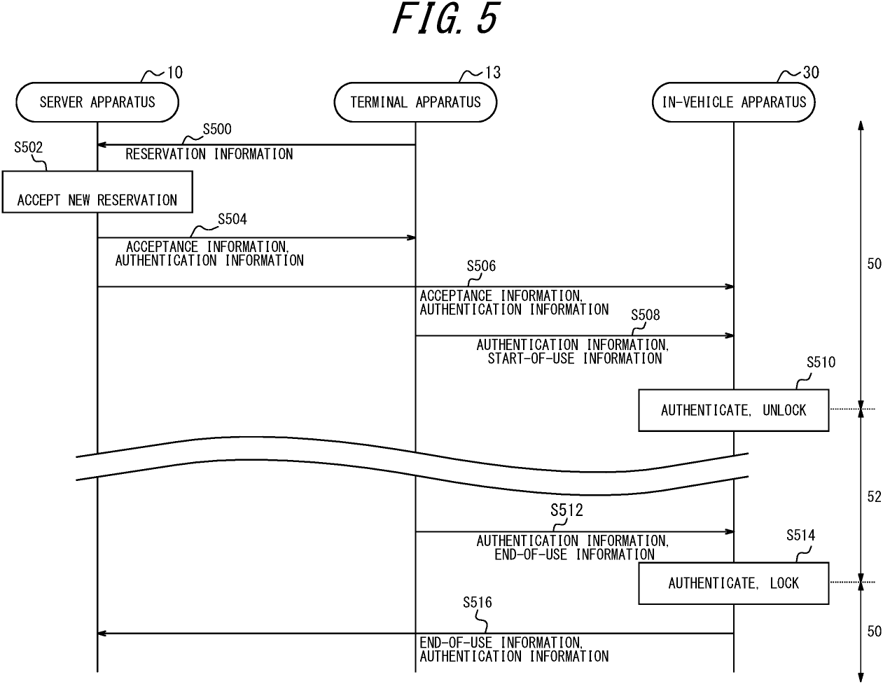

FIG. 5 is a sequence diagram to illustrate the operating procedures of the information processing system 1 in the present embodiment. FIG. 5 illustrates the procedures for the coordinated operation among the server apparatus 10, the in-vehicle apparatus 30, and the terminal apparatus 13 when car sharing takes place. Here, the procedures when the in-vehicle apparatus 30 operates as the “control apparatus” in the present embodiment are illustrated. The steps pertaining to the various information processing by the server apparatus 10, the in-vehicle apparatus 30, and the terminal apparatus 13 in FIG. 5 are performed by the respective controllers 23, 33, 43. The steps pertaining to transmitting and receiving various types of information to and from the server apparatus 10, the in-vehicle apparatus 30, and the terminal apparatus 13 are performed by the respective controllers 23, 33, 43 transmitting and receiving information to and from each other via the respective communication interfaces 21, 31, 41. In the server apparatus 10, the in-vehicle apparatus 30, and the terminal apparatus 13, the respective controllers 23, 33, 43 appropriately store the information that is transmitted and received in the respective memories 22, 32, 42. Furthermore, the controllers 23, 33, 43 accept input of various information by the respective input interfaces 35, 45 and output various information by the respective output interfaces 36, 46.

In step S500, the terminal apparatus 13 transmits reservation information for reserving use of the vehicle 12 to the server apparatus 10. For example, the user of the terminal apparatus 13 uses the terminal apparatus 13 to access a portal site, for members of the car sharing service, provided by the server apparatus 10. Information on the usable vehicles 12, the availability, and the like is displayed on the portal site. Such information is provided in advance, or as needed, by the terminal apparatus 13 used by the owner of the vehicle 12 and is maintained in the server apparatus 10. The user uses the terminal apparatus 13 to input the desired vehicle, the start time and end time of use, the user’s member ID, and the like and transmits the inputted information to the server apparatus 10 as reservation information for use. At this time, information identifying the terminal apparatus 13 is included in the reservation information.

In step S502, the server apparatus 10 searches for an existing reservation that could affect the acceptance of a reservation based on the reservation information for the terminal apparatus 13, and if no existing reservation is found, the server apparatus 10 accepts a new reservation based on the reservation information from the terminal apparatus 13. The information identifying the terminal apparatus 13, the user’s member ID, identification information on the desired vehicle 12, the start time of use, the end time of use, and other such information are stored in correspondence in the memory 22.

In step S504, the server apparatus 10 transmits acceptance information and authentication information to the server apparatus 10. The acceptance information includes, for example, information such as the reserved start time of use, the location of the vehicle 12, and the end time of use. The authentication information is used in the vehicle 12 to authenticate the user who made the reservation. The terminal apparatus 13 receives the information transmitted from the server apparatus 10.

In step S506, the server apparatus 10 transmits the acceptance information and the authentication information to the in-vehicle apparatus 30. The in-vehicle apparatus 30 receives the information transmitted from the server apparatus 10.

Step S508 is performed when the user begins using the vehicle 12. In step S508, the terminal apparatus 13 transmits the authentication information and the start-of-use information to the in-vehicle apparatus 30. The start-of-use information indicates the start of use based on the reservation. When the user starts using the vehicle 12 based on the reservation, the user approaches the vehicle 12 carrying the terminal apparatus 13 and operates the terminal apparatus 13 to transmit the authentication information and the start-of-use information to the in-vehicle apparatus 30. For example, a short-range communication interface of the communication interface 41 transmits the authentication information and the start-of-use information. An application for car sharing, for example, is installed on the terminal apparatus 13. When the user selects to start use from the menu of the application, the terminal apparatus 13 transmits the start-of-use information in response. The in-vehicle apparatus 30 receives the information transmitted from the terminal apparatus 13 using, for example, a short-range communication module of the communication interface 31.

In step S510, the in-vehicle apparatus 30 performs an authentication process and unlocks the vehicle 12. The in-vehicle apparatus 30 performs the authentication process based on the authentication information transmitted from the server apparatus 10 and the terminal apparatus 13. Once authentication is successful, the in-vehicle apparatus 30 stores the start-of-use information with a time stamp and instructs the ECU that controls the door locking of the vehicle 12 to unlock the doors. As a condition for successful authentication, the in-vehicle apparatus 30 may require that the time of receipt of the authentication information be within an appropriate range from the start time of use included in the acceptance information. Such operation of the in-vehicle apparatus 30 enables the user to board the vehicle 12 and begin using the vehicle 12.

Step S512 is performed when the user ends use of the vehicle 12. In step S512, the terminal apparatus 13 transmits the authentication information and end-of-use information to the in-vehicle apparatus 30. The end-of-use information is information indicating the end of use based on the reservation. When the user finishes using the vehicle 12 based on the reservation, the user exits the vehicle 12 and operates the terminal apparatus 13 to transmit the authentication information and the end-of-use information to the in-vehicle apparatus 30. For example, when the user selects to end use from the menu of the application for car sharing, the terminal apparatus 13 transmits the end-of-use information via the short-range communication interface in response. The in-vehicle apparatus 30 receives information transmitted from the terminal apparatus 13 using, for example, the short-range communication interface of the communication interface 31.

In step S514, the in-vehicle apparatus 30 performs the authentication process and locks the vehicle 12. The in-vehicle apparatus 30 performs the authentication process based on the authentication information, and once the authentication is successful, the in-vehicle apparatus 30 stores the end-of-use information along with a time stamp and instructs the ECU that controls the door locking of the vehicle 12 to lock the doors. Such operation of the in-vehicle apparatus 30 enables the user to end the use of the vehicle 12. After storing the end-of-use information, the in-vehicle apparatus 30 may invalidate the authentication information. This configuration can improve the security of the vehicle 12.

In step S516, the in-vehicle apparatus 30 transmits the end-of-use information and the authentication information to the server apparatus 10. The end-of-use information indicates that the use of the vehicle 12 corresponding to the authentication information has ended. The server apparatus 10 receives the information transmitted from the in-vehicle apparatus 30.

In FIG. 5, based on the information that the in-vehicle apparatus 30 receives from the terminal apparatus 13, a user usage period 51 during which the user uses the vehicle 12 is partitioned from an owner usage period 50 during which the owner uses the vehicle 12. For example, steps S510 to S514 correspond to the user usage period 51, and the other steps correspond to the owner usage period 50.

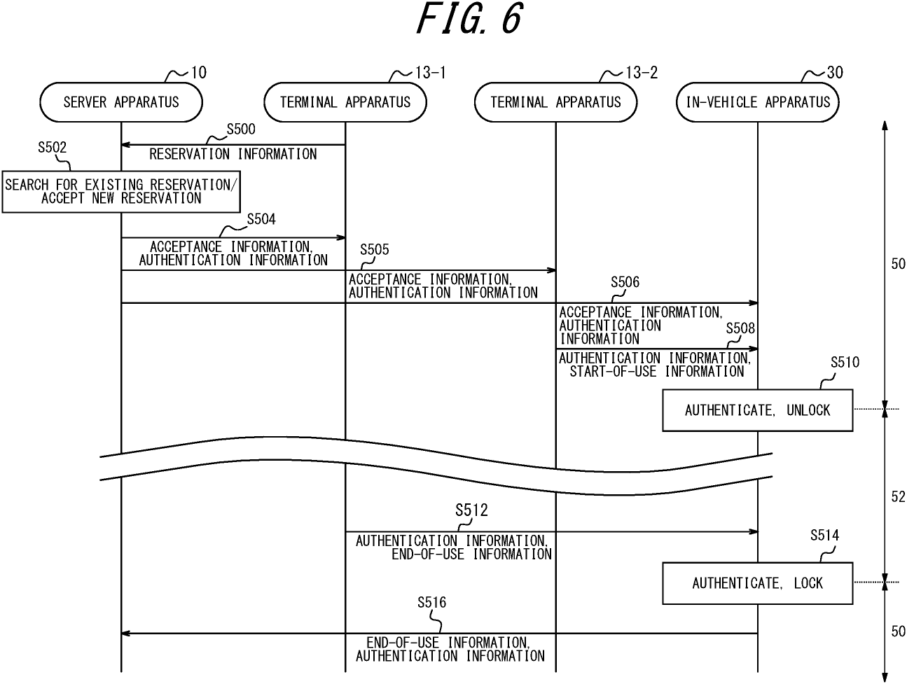

FIG. 6 illustrates the procedures for a variation of FIG. 5. In this variation, when a user reserves the use of a vehicle 12, a staff member of the car sharing service provider delivers the vehicle 12 to the user. This configuration can improve user convenience. Here, the terminal apparatuses 13 used by the user and staff member are terminal apparatuses 13-1 and 13-2, respectively. FIG. 6 differs from FIG. 5 in the following respects.

In step S500, the reservation information is transmitted from the terminal apparatus 13-1 used by the user to the server apparatus 10. Then, in step S504, the acceptance information and the authentication information are transmitted from the server apparatus 10 to the terminal apparatus 13-1. Furthermore, in step S505, which is added to FIG. 5, the server apparatus 10 transmits the acceptance information and the authentication information to the terminal apparatus 13-2. This enables the staff member to begin using the vehicle 12 with the terminal apparatus 13-2.

In step S508, the authentication information and the start-of-use information are transmitted to the in-vehicle apparatus 30 from the terminal apparatus 13-2 used by the staff member. The staff member begins using the vehicle 12 and drives the vehicle 12 to deliver the vehicle 12 to the user. The user receives the vehicle 12 from the staff member and begins using the vehicle 12. Then, in step S512 at the end of use, the authentication information and the end-of-use information are transmitted from the terminal apparatus 13-2 used by the user to the in-vehicle apparatus 30.

Here, the in-vehicle apparatus 30 receives the authentication information and the start-of-use information from the terminal apparatus 13-1 and the authentication information and the end-of-use information from the terminal apparatus 13-2 but as in FIG. 5, the steps from step S510 to step S514 correspond to the user usage period 52, and the other steps correspond to the owner usage period 50.

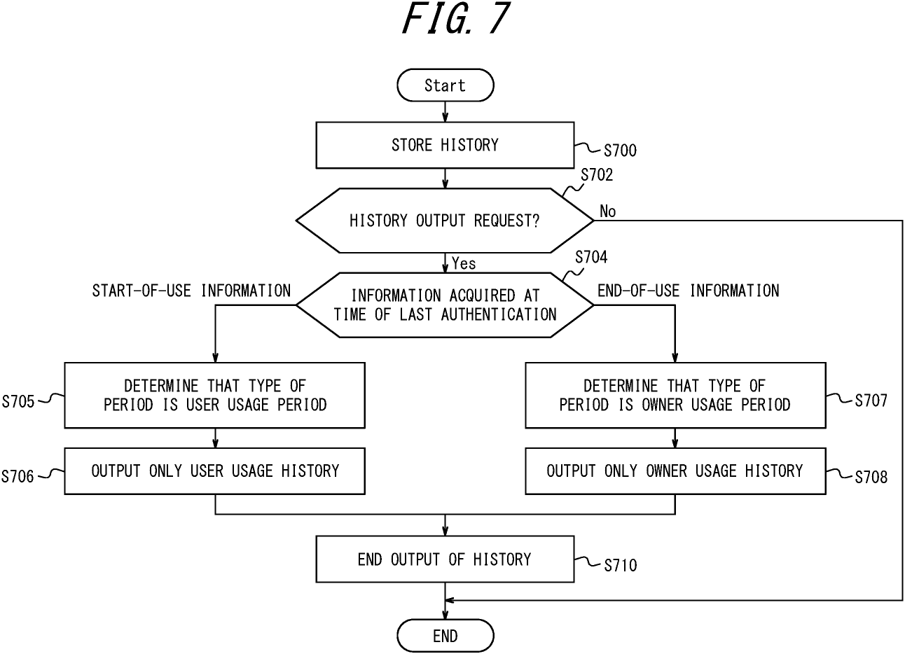

In the procedures of FIG. 5 or FIG. 6, the in-vehicle apparatus 30 stores the history of travel of the vehicle 12 in the memory 32 during the owner usage period 50 and the user usage period 52. The owner, the user, or a staff member might check the history when using the vehicle 12. The operation procedures of the in-vehicle apparatus 30 in such a case are illustrated in FIG. 7.

FIG. 7 is a flowchart illustrating the operation procedures for the controller 33 of the in-vehicle apparatus 30. The procedures in FIG. 7 are performed in any appropriate cycles (for example, in cycles of several milliseconds to several seconds).

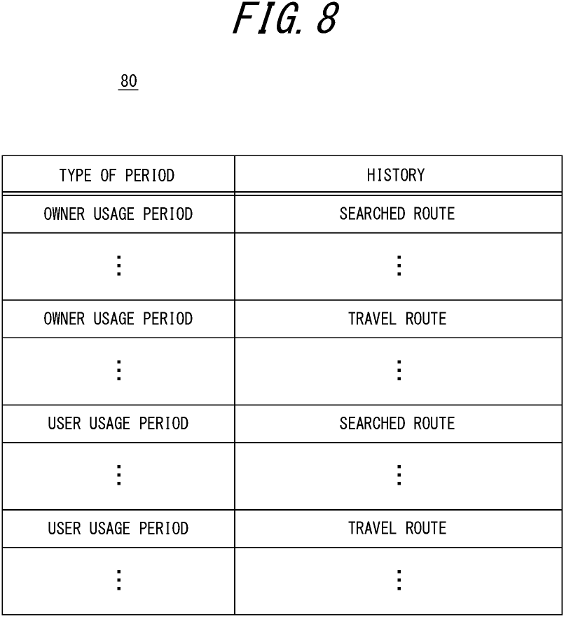

In step S700, the controller 33 stores the history of travel of the vehicle 12 in the memory 32. The history is stored in a table 80 as illustrated in FIG. 8, for example, in association with the type of period at the time the history was acquired. The type of period is the owner usage period or the user usage period. For example, the initial value of the type of period is the owner usage period, and the controller 33 determines the type of period in step S705 or S707, described below. The history includes information on a searched route, a travel route, points included in the searched route or the travel route, and the like. The history corresponding to the owner usage period is owner usage history, and the history corresponding to the user usage period is user usage history.

In step S702, the controller 23 determines the existence of a history output request. A history output request is transmitted to the controller 33 by the owner, a user, or a staff member performing an operation, on the input interface 35 of the in-vehicle apparatus 30, to request output of the history. In a case in which a history output request is received (Yes), the controller 23 proceeds to step S704. In contrast, in a case in which a history output request is not received (No), the controller 23 terminates the procedures in FIG. 7.

In step S704, the controller 33 determines whether the information acquired when the last authentication process was executed is start-of-use information or end-of-use information.

In a case in which the start-of-use information was acquired when the last authentication process was executed, the current period is the user usage period 52 in FIGS. 5 and 6. In that case, the controller 33 performs step S706. In step S706, the controller 33 outputs only the user usage history. For example, the user usage history is displayed on the display of the output interface 36 in any appropriate form.

In a case in which the end-of-use information was acquired when the last authentication process was executed, the current period is the owner usage period 50 in FIGS. 5 and 6. In that case, the controller 33 performs step S708. In step S708, the controller 33 outputs only the owner usage history. For example, the owner usage history is displayed on the display of the output interface 36 in any appropriate form.

After step S706 or S708, the controller 33 terminates the output of the history in step S710. For example, after any appropriate display time (such as ten seconds to several tens of seconds), the display ends. The controller 33 then terminates the procedures of FIG. 7.

According to the above procedures, the user usage history is outputted during the user usage period (including the period of use of the vehicle 12 by the staff member), and the owner usage history is not outputted, thus enabling the owner to provide the vehicle 12 for car sharing without having to worry that the owner’s own usage history will be seen by the user or staff member. On the other hand, the owner usage history is outputted during the owner usage period, whereas the user usage history is not outputted, thus enabling the user to use the car sharing service without having to worry that the user’s own usage history will be seen by the owner. Thus, not only the convenience for the owner but also the convenience for the user can be improved.

The procedures in FIGS. 5 to 7 are for the case in which the in-vehicle apparatus 30 corresponds to the “control apparatus” of the present embodiment, but in a case in which the server apparatus 10 corresponds to the “control apparatus”, the procedures in FIGS. 5 to 7 are modified as follows.

First, in FIGS. 5 and 6, the in-vehicle apparatus 30 transmits the authentication information and the start-of-use information received from the terminal apparatus 13 or 13-2 in step S508 to the server apparatus 10, the server apparatus performs authentication processing, and the authentication results are transmitted to the in-vehicle apparatus 30. Instead of step S510, the in-vehicle apparatus 30 then unlocks the doors based on the authentication results from the server apparatus 10. Also, the in-vehicle apparatus 30 transmits the authentication information and the end-of-use information received from the terminal apparatus 13 or 13-1 in step S512 to the server apparatus 10, the server apparatus performs authentication processing, and the authentication results are transmitted to the in-vehicle apparatus 30. Instead of step S514, the in-vehicle apparatus 30 then locks the doors based on the authentication results from the server apparatus 10.

The procedures in FIG. 7 are performed by the controller 23 of the server apparatus 10. In step S700, the controller 23 acquires the history information from the in-vehicle apparatus 30 and stores the history information. In step S702, the controller 23 acquires information indicating the existence of a history output request from the in-vehicle apparatus 30 and makes a determination. The controller 23 then transmits, to the in-vehicle apparatus 30, an instruction to output the usage history in steps S706 and S708 and an instruction to terminate the history output in step S710.

Alternatively, in a case in which the server apparatus 10 and the in-vehicle apparatus 30 cooperate to correspond to the “control apparatus”, the in-vehicle apparatus 30 may store the history, for example, while the server apparatus 10 determines the type of usage period and generates an output instruction for the usage history according to the determination results.

In the above embodiment, a processing/control program that specifies operations of the vehicle 12 and the terminal apparatus 13 may be stored in the memory 22 of the server apparatus 10 or in the memory of another server apparatus and be downloaded onto each apparatus via the network 11. The processing/control program may also be stored on a non-transitory recording/storage medium readable by each apparatus, and each apparatus may read the program from the medium.

While embodiments have been described with reference to the drawings and examples, it should be noted that various modifications and revisions may be implemented by those skilled in the art based on the present disclosure. Accordingly, such modifications and revisions are included within the scope of the present disclosure. For example, functions or the like included in each means, each step, or the like can be rearranged without logical inconsistency, and a plurality of means, steps, or the like can be combined into one or divided.

1. A control apparatus comprising:
a memory configured to store a history of travel of a vehicle;
a communication interface; and
a controller configured to transmit and receive information to and from another apparatus via the communication interface, wherein
the controller is configured to output a first history for a first period in response to a predetermined instruction during the first period and to refrain from outputting the first history, even upon receiving the predetermined instruction, during a second period partitioned from the first period based on information transmitted by a terminal apparatus.

2. The control apparatus according to claim 1, wherein the controller is configured to output a second history for the second period in response to the predetermined instruction during the second period and to refrain from outputting the second history, even upon receiving the predetermined instruction, during the first period.

3. The control apparatus according to claim 1, wherein the information transmitted by the terminal apparatus is start information indicating a start of the second period or end information indicating an end of the second period.

4. The control apparatus according to claim 3, wherein the start information or the end information is acquired on the terminal apparatus by a user of the terminal apparatus reserving use of the vehicle.

5. The control apparatus according to claim 3, wherein the controller is configured to receive the start information and the end information from different terminal apparatuses.

6. The control apparatus according to claim 3, wherein the controller is configured to output an instruction to unlock the vehicle upon receiving the start information or to lock the vehicle upon receiving the end information.

7. The control apparatus according to claim 1, wherein the history includes information on a searched route, a travel route, and points included in the searched route or the travel route.

8. A system comprising a control apparatus and a terminal apparatus configured to communicate information with each other, wherein
the control apparatus is configured to store a history of travel of a vehicle and output a first history for a first period in response to a predetermined instruction during the first period,
the terminal apparatus is configured to transmit information for partitioning a second period from the first period to the control apparatus, and
the control apparatus is configured to refrain from outputting the first history, even upon receiving the predetermined instruction, during the second period.

9. The system according to claim 8, wherein the control apparatus is configured to output a second history for the second period in response to the predetermined instruction during the second period and to refrain from outputting the second history, even upon receiving the predetermined instruction, during the first period.

10. The system according to claim 8, wherein the information transmitted by the terminal apparatus to the control apparatus is start information indicating a start of the second period or end information indicating an end of the second period.

11. The system according to claim 10, wherein the terminal apparatus is configured to acquire the start information or the end information by a user performing a process to reserve use of the vehicle.

12. The system according to claim 10, wherein the control apparatus is configured to receive the start information and the end information from different terminal apparatuses.

13. The system according to claim 10, wherein the control apparatus is configured to output an instruction to unlock the vehicle upon receiving the start information or to lock the vehicle upon receiving the end information.

14. The system according to claim 8, wherein the history includes information on a searched route, a travel route, and points included in the searched route or the travel route.

15. An operating method of a system comprising a control apparatus and a terminal apparatus configured to communicate information with each other, the operating method comprising:
storing, by the control apparatus, a history of travel of a vehicle and outputting a first history for a first period in response to a predetermined instruction during the first period; and
transmitting, by the terminal apparatus, information for partitioning a second period from the first period to the control apparatus, wherein
the control apparatus refrains from outputting the first history, even upon receiving the predetermined instruction, during the second period.

16. The operating method of a system according to claim 15, wherein the control apparatus outputs a second history for the second period in response to the predetermined instruction during the second period and refrains from outputting the second history, even upon receiving the predetermined instruction, during the first period.

17. The operating method of a system according to claim 15, wherein the information transmitted by the terminal apparatus to the control apparatus is start information indicating a start of the second period or end information indicating an end of the second period.

18. The operating method of a system according to claim 17, wherein the terminal apparatus acquires the start information or the end information by a user performing a process to reserve use of the vehicle.

19. The operating method of a system according to claim 17, wherein the control apparatus receives the start information and the end information from different terminal apparatuses.

20. The operating method of a system according to claim 17, wherein the control apparatus outputs an instruction to unlock the vehicle upon receiving the start information or an instruction to lock the vehicle upon receiving the end information.
